(19) United States
(12) Patent Application Publication
(10) Pub. No.: US 2011/0109905 A1
(43) Pub. Date: May 12, 2011

(54) ARRANGEMENT ADAPTED FOR SPECTRAL ANALYSIS

(75) Inventor: Hans Göran Evald Martin, Delsbo (SE)

(73) Assignee: SENSEAIR AB, Delsbo (SE)

(21) Appl. No.: 13/001,885

(22) PCT Filed: Jun. 10, 2009
(86) PCT No.: PCT/SE2009/050705

§ 371 Date: Dec. 29, 2010

(30) Foreign Application Priority Data
Jun. 30, 2008 (SE) 0801550-5

(51) Int. Cl. G01J 3/26

(52) U.S. Cl. 356/326

(57) ABSTRACT

An arrangement adapted for a spectral analysis, having a light transmitting means, a delimited space in the form of a cavity serving as a measuring cell and defining an optical measuring distance, a light sensing means for detecting radiation passing said optical measuring distance from said light transmitting means, and a unit, connected at least to said light sensing means and performing the spectral analysis. Beams of radiation from the light transmitting means are made to pass through an optical band-pass filter at different angles of incidence. The filter is structured so as to pass a wavelength in dependence of the angle of incidence. A first chosen wavelength component is separated from a second wavelength component, each being received in its opto-electric means. Said unit is adapted for detecting and calculating an occurring radiation intensity for each such wavelength component.

### TECHNICAL FIELD OF THE INVENTION

This invention generally refers to an arrangement adapted for an evaluation of electromagnetic radiations.

More particularly the invention concerns an arrangement adapted for spectral analysis of wavelengths, wherein it has turned out to be possible in a simple and cost effective manner to spectrally analyse light intensities for wavelength components and/or spectral elements lying closely adjacent with regard to its wavelengths.

The practical application of the invention will be more thoroughly described in the following in connection with a gas meter in order to determine the occurrence of and the concentration of a sample of gas adapted for said evaluation.

Such a gas adapted arrangement is then to exhibit; a light transmitting means, adapted for an electromagnetic radiation, a cavity, serving as a measuring cell and a measuring path for a sample of gas and intended to be able to define an optical measuring distance valid for said measurement, a light sensing means, adapted for sensing the radiation of said electromagnetic radiation passing said optical measuring distance from said light transmitting means, and a unit, adapted for performing the spectral analysis and being connected at least to said light sensing means.

The mentioned means, sensing the electromagnetic radiation, is opto-electrically sensitive adapted for the electromagnetic radiation which is intended to fall within a spectral area, whose chosen wavelength components or spectral elements are to become objects of an analysis in said unit performing the spectral analysis to let the relative intensity of radiation of the spectral element to be determined.

Within this technical area there are here allotted and utilized light transmitting means and light sensing means which are known earner together with units performing spectral analyses and display units connected or related thereto and presenting the results, and therefore these means, units and display units will not be the objects of a more specific survey and elucidation in this application with regard to the structural composition.

### BACKGROUND OF THE INVENTION

Methods, arrangements and structures related to the above-mentioned technical area and nature are known earlier in a plurality of different embodiments.

As a first example of the background of technology and the technical field to which the present invention refers may be mentioned an arrangement adapted for a spectral analysis of a sample of gas with a light transmitting means adapted for an electromagnetic radiation, a restricted space, in the form of a cavity, serving as a measuring cell and intended to be able to define an optical measuring distance or path, a light sensing means for said electromagnetic radiation passing said optical measuring distance from said light transmitting means and a unit performing the spectral analysis of the sample of gas connected at least to said light sensing means in the form of opto-electric detectors.

Said sensing means, sensing electromagnetic radiation, is opto-electrically adapted sensitive to the electromagnetic radiation, which is intended to fall within the spectral field whose chosen wavelength components or spectral elements are to become objects of an analysis in the unit performing the spectral analysis in order to determine, within this unit, the relative radiation intensity of the spectral element for relevant wavelength sections.

Reference is here made to U.S. Pat. No. 5,009,493-A, German Patent DE-4 110 653-A1, U.S. Pat. No. 5,268,782-A and U.S. Pat. No. 4,029,521-A.

As a more specific first example of an arrangement indicated here, and analysing a sample of gas reference is made to the contents of the International Patent Application No. PCT/SE99/00145 (WO 99/41 592) comprising a method of producing a detector adapted to a gas sensor and a detector produced in this manner.

As a more specific second example of the arrangement indicated here reference is made to the contents of the International Patent Application, having the publication number WO 97/18460.

As a third specific example of the arrangement indicated here reference is made to the contents of the international Patent Application, having the publication number WO 98/09152.

In addition, reference is made to the contents of the International Patent Application, having the publication number WO 01/81 901.

In consideration of the characteristics associated with the present invention different kinds of optical band-pass filters can be noted.

Hence, it is known to supply at a right angle to a band-pass filter an electromagnetic or optical radiation having a large wavelength area and to create within the filter conditions for letting a chosen narrow wavelength area pass through to an opto-electric detector, in order to expose and determine through this detector the intensity of a narrow wavelength area or band which is to be evaluated.

Such a band-pass filter can also be supplied with an electromagnetic radiation or optical radiation within an angular area, deviating from said right angle, and such band-pass filter is thus structured and/or designed to create prerequisites for letting through another chosen narrow wavelength areas or bands.

Such band-pass filters will thus be able to offer a wavelength passage dependent of a chosen angle of incidence and transmission of the radiation coming in and through said band-pass filter.

When considering the significant features of the present invention, it is to be mentioned the content of the Patent Publication JP-7 128 231-A.

This patent publication is disclosing a construction of an infrared gas sensor and is concentrated to provide an infrared gas sensor with simple structure and capable of detecting the generation and increase of a gas to be detected while monitoring the generation and increase of an interfering gas in a space to be detected.

This construction is utilizing the property that a wavelength maximizing the transmission of an interference filter (6) depends on the incident angle, the generation and increase of a gas to be detected are detected by the use of light (12) vertically incident to the interference filter, and the generation and increase of an interfering gas are detected by use of the light (13) incident on the interference filter (6) at an incident angle.

The used light detectors (7, 8) are each receiving its wavelength and through a circuit (9) these two wavelengths are combined (added to each other) to a single wave-length, for further prosecution in a unit (10).

The prior art also includes a method and an apparatus for measuring wave-length changes in a high-resolution measurement system (US-2004/0 057 041-A1).

More specifically this patent application is covering a method and an apparatus for measuring a wavelength-related characteristic of a radiation source.

Two beams travel through substantially identical filters at different angles, which produces two different output signals (132, 136) that behave similarly with respect to power and/or temperature variations.

In various embodiments, the two beams (106, 107) are filtered through two portions of a single filter.

A diffraction grating may be mounted to the filter to split incident radiation into first and second beams. The beams thus travel through the filter at different angles, to produce two output signals that can be combined to compensate for common mode errors as well as power variations.

Extremely small size and high-resolution may be achieved and single or multiple detectors may also be used.

Filter temperature sensitivities may also be compensated based on a direct temperature measurement or based on outputs derived from two additional beams through filters with a different temperature dependency from the filters used for the first two beams.

Alternatively, the angle at which a beam travels through a filter may be physically adjusted to compensate for temperature change.

### DESCRIPTION OF THE PRESENT INVENTION

### Technical Problem

If the circumstance is considered, that the technical considerations which a person skilled in the art in the relevant technical field must carry out in order to offer a solution to one or more technical problems set up are on the one hand initially a necessary insight into the measures and/or the sequence of measures which are to be taken, and on the other hand a necessary choice of the means which are necessary, in consideration of this, the following technical problems should be relevant in producing the present object of invention.

Considering the earlier standpoint of technology, as it is described above, it should therefore have to be seen as a technical problem to be able to understand the significance of, the advantages related to and/or the technical measures and considerations which will be needed for in an arrangement, adapted for spectral analysis, offering a simple and cost effective way of spectrally having the intensity of electromagnetic radiations or light radiations from one and the same band-pass filter analysed in a general application and for having a sample of gas analysed within a limited scope in a specific application.

There is a technical problem in being able to understand the significance of, the advantages related to and/or the technical measures and considerations which will be needed for, in the latter application and for having a sample of gas analysed, letting this be built on an arrangement having a space, in the form of a cavity, serving as a measuring cell for a light transmitting means, adapted for electromagnetic radiation, and in the form of a cavity, serving as a measuring cell, and being intended to be able to define an optical measuring distance or path through the sample of gas, a light sensing means for sensing said electromagnetic radiation passing through said optical measuring distance from said light transmitting means, and at least one to said light sensing means connected to a unit carrying out the spectral analysis, wherein said light sensing means sensing the electromagnetic radiation is opto-electrically sensitively adapted to the electromagnetic radiation which is intended to fall within (the wave-length component or) the spectral area or band whose chosen spectral elements are to become the object of an analysis in the unit performing the spectral analysis, so as in this unit to have determined the relative intensitivity of the radiation of the spectral elements and present the latter on a display unit or a corresponding means as well as to disclose an arrangement in which it is possible, in simple manner and cost effectively, to be able to spectrally analyse the intensity of components lying close to each other in terms of wavelengths or spectral elements of a light or electromagnetic light cluster combined of different wave-lengths.

There is a technical problem in being able to understand the significance of, the advantages related to and/or the technical measures and considerations which will be required for having the mutual relationship with regard to each other of signal intensities measured and in such a case only for specific and close wavelength components and/or spectral elements.

There is a technical problem in being able to understand the significance of, the advantages related to and/or the technical measures and considerations which will be required for letting a limited spectral analysis be adapted to a measuring technology within gas analysis and gas concentration measuring wherein there is required a specific “spectral signature” or a “signal imprint” for letting these become the basis of a matter-unique identification and/or determination of a content.

There is a technical problem in being able to understand the significance of, the advantages related to and/or the technical measures and considerations which will be required for letting a small number of wavelength specific measuring points or spectral elements, but at least one wavelength point per matter, become the object of identification and/or surveillance.

There is a technical problem in being able to understand the significance of, the advantages related to and/or the technical measures and considerations which will be required for utilizing electromagnetic band-pass filters, for being able to create measuring signals at fixed predetermined wavelengths, in accordance with the principles of a non-dispersive infrared technology (Non-Dispersive Infrared or NDIR Technology).

There is a technical problem in being able to understand the significance of, the advantages related to and/or the technical measures and considerations which will be required for letting the mentioned electromagnetic radiation be adapted to pass an adapted optical band-pass filter, between said light transmitting means and said light sensing means.

There is a technical problem in being able to understand the significance of, the advantages related to and/or the technical measures and considerations which will be needed for letting such band-pass filter be structured and constructed for being able to offer a wavelength dependent of the angle of incidence in the transmission of the light transmitting means generated and transmitted electromagnetic radiation within a large wavelength area.

There is a technical problem in being able to understand the significance of, the advantages related to and/or the technical measures and considerations which will be required for at that time letting this band-pass filter, by its structure and by chosen angles of incidence or similar, be adapted to separate a first chosen spectral element or a first wavelength component from a second chosen spectral element or a second wave-length component within one and the same transmitted electromagnetic radiation.

There is a technical problem in being able to understand the significance of, the advantages related to and/or the technical measures and considerations which will be required for letting said unit be adapted for being able to detect electrically an occurring radiation intensity pertinent to more than one wavelength component and/or one spectral element.

There is a technical problem in being able to understand the significance of, the advantages related to and/or the technical measures and considerations which will be required for having disposed, adjacent to said band-pass filter, an opening or a window delimiting the dispersion angle of the transmitted electromagnetic radiation.

There is a technical problem in being able to understand the significance of, the advantages related to and/or the technical measures and considerations which will be required for let-ting said opening or window, counted in the direction of radiation, be oriented before or after a utilized band-pass filter.

There is a technical problem in being able to understand the significance of, the advantages related to and/or the technical measures and considerations which will be required for letting the optical (electromagnetic) band-pass filter be adapted to be able to deflect an incident and transmitted optical or electromagnetically radiation to at least two different optical and predetermined outwards falling or outgoing angles for narrow wavelength components and/or spectral elements.

There is a technical problem in being able to understand the significance of, the advantages related to and/or the technical measures and considerations which will be required for letting said outwards falling or outgoing angles for the narrow wavelength component and its radiation to be exactly related to a main angle of the incoming electromagnetic radiation, which over its associated detector is to become the object of analysis within the unit performing the spectral analysis.

There is a technical problem in being able to understand the significance of, the advantages related to and/or the technical measures and considerations which will be required for letting one and the same band-pass filter be adapted for receiving one and the same light transmitted and incoming electromagnetic radiation, in which radiation at least two different and chosen wave-length components or spectral elements are included.

There is a technical problem in being able to understand the significance of, the advantages related to and/or the technical measures and considerations which will be required for letting a predetermined number of band-pass filters be so adapted that each is receiving its or the same transmitted electromagnetic radiation, within which radiation or radiations expose at least two different wavelength components or spectral elements.

There is a technical problem in being able to understand the significance of, the advantages related to and/or the technical measures and considerations which will be required for indicating the presence of an opto-electric detector for each or each chosen, outwards falling or outgoing angle for the radiations, said detector being adapted in its associated unit for performing spectral analysis to have its electric associated wave-length component or its associated spectral element analysed.

There is a technical problem in being able to understand the significance of, the advantages related to and/or the technical measures and considerations which will be required for choosing a filter active for an optical interference as said optical band-pass filter.

There is a technical problem in being able to understand the significance of, the advantages related to and/or the technical measures and considerations which will be required for letting said opening or window, said band-pass filter and/or included channels related to said unit, performing said spectral analysis, be coordinated to one and the same means receiving and/or sensing light signals.

There is a technical problem in being able to understand the significance of, the advantages related to and/or the technical measures and considerations which will be required for letting said opening or window, said band-pass filter and said channels, be coordinated to one and the same discrete light receiver unit.

There is a technical problem in being able to understand the significance of, the advantages related to and/or the technical measures and considerations which will be required for letting such a receiver unit take the form of a hybrid unit.

There is a technical problem in being able to understand the significance of, the advantages related to and/or the technical measures and considerations which will be required for letting said restricted space, shaped as a cavity, a measuring portion and/or an optical measuring distance, be associated with a straight or other external shape, between the light transmitting means and the light sensing means or detectors or light receiver part.

There is a technical problem in being able to understand the significance of, the advantages related to and/or the technical measures and considerations which will be required for letting the light transmitting means be given the form of a first discrete unit and the light sensing means be given the form of a second discrete unit adapted to cooperate with an intermediate aperture-shaped partial portion with an inlet and an outlet a the medium utilized for sensing the sample of gas and the unit intended for analysing.

There is a technical problem in being able to understand the significance of, the advantages related to and/or the technical measures and considerations which will be required for letting a medium intended for a sensing and/or an analysing, consist of expiration air and wherein a chosen sensing means and/or analysing unit may be directed to letting determine the existence of and/or relevant concentration of alcohol or corresponding gas-bonded drugs.

There is a technical problem in being able to understand the significance of, the advantages related to and/or the technical measures and considerations which will be required in order to determine an instantaneously occurring concentration of carbon dioxide (CO₂).

There is a technical problem in being able to understand the significance of, the advantages related to and/or the technical measures and considerations which will be required for letting the end portion of a restricted space, facing the light sensing means, exhibit a surface section reflecting electromagnetic radiation in order to deflect radiation portions obliquely towards one or more externally positioned band-pass filters and/or wavelength significant detectors lying outside said restricted space.

There is a technical problem in being able to understand the significance of, the advantages related to and/or the technical measures and considerations which will be required for letting electromagnetic radiation or a light ray (a narrow light ray beam) or a chosen amount of light rays be adapted to be directed straight towards an opto-electric detector from a light transmitting means whereas other light rays are to be directed to other opto-electric detectors.

### The Solution

The present invention takes as its starting point the known technology mentioned by way of introduction and is based on an arrangement adapted for spectral analysis with a light transmitting means adapted for electromagnetic radiation in accordance with the preamble of claim 1 or alternatively in accordance with the preamble of claim 2.

In addition to said transmitting means the arrangement is for analysing a sample of gas in addition to indicate a restricted space, in the form of a cavity, serving as a measuring cell, intended for the sample of gas and intended to be able to define an optical measuring distance or path, a light sensing means for said electromagnetic radiation passing said optical measuring distance from said light transmitting means, and a unit, connected at least to said light sensing means, performing spectral analysis, wherein said light sensing means, sensing the electromagnetic radiation, is adapted to be sensitive for the electromagnetic radiation which is intended to fall within the spectral area whose chosen wavelength components and/or spectral elements are to become the object of an analysis within the unit performing the spectral analysis for letting, within said unit determine the relative radiation intensity of the wavelength components or the spectral elements.

In order to solve one or more of the technical problems mentioned above the present invention more particularly indicates that the mentioned technology as known is to be supplemented by letting said transmitted electromagnetic radiation be adapted between said light transmitting means and said light sensing means to pass a frequency and/or wavelength adapted optical band-pass filter, with said band-pass filter being structured and/or designed to be able to offer a wavelength dependent of the angle of incidence in the transmission of the electromagnetic radiation generated by said transmitting means.

This band-pass filter is adapted to have a first chosen wavelength component or narrow area or a first chosen spectral element separated by a wavelength from a second chosen wave-length component or narrow area or a second chosen spectral element within the transmitted electromagnetic radiation and said unit is adapted to be able to detect via an opto-electric detector occurring radiation intensities for or from more than one such spectral element.

As proposed embodiments falling within the framework of the basic concept of the present invention it is additionally indicated that adjacent to said band-pass filter is to be disposed an opening or a window delimiting the diverging angle of the transmitted electromagnetic radiation.

It is further indicated that said opening or window, counting in the direction of radiation, should be oriented in the direction of transmission counted immediately in front of or behind the optical band-pass filter.

The optical band-pass filter is here adapted to let an incident electromagnetic radiation be deflected in at least two different predetermined outwards falling or outgoing angles of the electromagnetic radiations.

Said outwardly falling radiations of the electromagnetic radiations, adapted to said angles, are then to be related to an associated main angle for the incident radiation which is to become the object of an analysis within the unit, performing the spectral analysis.

More particularly it is indicated that one and the same band-pass filter is to be adapted to receive one and the same electromagnetic radiation, within which radiation fall at least two different wavelength components or spectral elements.

In a proposed embodiment it is indicated more particularly that a number of band-pass filters chosen beforehand can be adapted to receive individual transmitted electromagnetic radiations, within which radiations at least two different wavelength components or spectral elements fall.

For each outwards falling or outgoing angle for the radiation or for each chosen such there is an opto-electric detector which then is adapted such, that in its unit, performing the spectral analysis, it has its associated and by the unit received wavelength component or its associated spectral element analysed.

As said optical band-pass filter can to advantage be chosen a filter active on the basis of optic interference.

Said opening or window, said optical band-pass filter and/or incoming channels related to said unit, performing the spectral analysis, are coordinated to means receiving and/or sensing one and the same signals.

Said opening, band-pass filter and said channels can then be coordinated to one and the same receiver unit.

The receiver unit will then have the form of a hybrid unit.

Said delimited space, shaped as a cavity, a measuring cell and/or an optical measuring distance can to advantage be associated with a straight and/or light reflecting shape and extension between the light transmitting means and the light sensing means or a receiver portion.

The light transmitting means is shaped as a first discrete unit and the light sensing means is formed as a second discrete unit adapted to cooperate between an intermediate aperture-shaped partial portion with an inlet and an outlet for the medium intended for sensing and analysing.

The unit intended for sensing and/or analysing can then preferably be based on samples of gas which can consist of the exhalation air of a person and wherein, sensing in a detector and/or analysing in the unit, it is directed or determined the occurrence of and/or concentration of alcohol or corresponding drugs handled by the exhalation air in a gas phase.

Evaluation of the occurrence of and a concentration of carbon dioxide (CO₂), as in air or in an exhalation area, also falls within the scope of the invention.

The end portion of the delimited space facing the light sensing means exhibits a surface portion reflecting the electromagnetic radiation for changing the angle of the electromagnetic radiation obliquely towards an adjacent band-pass filter.

A ray of light (in the form of a narrow electromagnetic cluster of radiation) or a chosen portion of light rays may to advantage be adapted to be directed directly at a right angle to an opto-electric detector from a light transmitting means.

### Advantages

The advantages which primarily must be considered to be characterizing of the present invention and the thereby allotted specific significant characteristics are that hereby prerequisites have been created for an arrangement adapted for spectral analysis, having a light transmitting means adapted for electromagnetic radiation, a space, light sensing means for said electromagnetic radiation from said light transmitting means, and a unit connected at least to said sensing means and performing the spectral analysis, wherein the mentioned means, sensing the electromagnetic radiation, are to be adapted sensitively to a filter passing electromagnetic radiation which is intended to fall within the spectral field or area whose chosen wavelength components and/or spectral elements are to become the objects of an analysis in the unit, performing the spectral analysis, for within this unit, by different calculations, having the relative radiation intensity of the spectral element determined, having determined that said transmitted electromagnetic radiation between said light transmitting means and said light sensing means is to be adapted to be able to pass an adapted and/or constructed optical band-pass filter in which the band-pass filter, is structured for being able to offer a wave-length dependent of the entrance angle for transmission of the electromagnetic radiation generated and transmitted from said light transmitting means.

This single band-pass filter is thus adapted to separate a first selected wave-length component and/or a first chosen spectral element from a second chosen wave-length component and/or a second chosen spectral element and said unit is adapted to be able to separately detect and calculate the intensity of an occurring wavelength component or radiation intensity for more than one wavelength component or spectral element.

What primarily must be considered to be characterizing of the present invention is disclosed in the characterizing portions of the following claim 1 and claim 2.

### SHORT DESCRIPTION OF THE DRAWINGS

A presently proposed embodiment, illustrating the significant characteristics associated with the present invention, will now be described with the purpose of exemplification with reference to the accompanying drawings, in which;

FIG. 1 shows the principle for measuring gas, while utilizing NDIR-technology with a light transmitting means, a delimited space adapted for a sample of gas, a light receiving means and an associated display unit,

FIG. 2 shows the principle of a known receiver unit or a light sensing means in a one channel measurement (Single Beam NDIR Technology),

FIG. 3 shows the principle of a known receiver unit or a light sensing means in a two channel measurement (Dual Beam NDIR Technology),

FIG. 4 shows a graph of an application in a two channel measurement, utilizing a carbon dioxide sensor and by a differential absorption measurement with the x-axis allotted values corresponding to 1/λ, using different time slots “t1” followed by “t2” or the same time slot, (CO₂ Absorption Spectrum with two filter curves for standard dual wavelength, NDIR CO₂ monitoring).

FIG. 5 shows the principles of a two channel measurement by selective electric scanning of an interference filter on the basis of time, (“t1” is followed by “t2” and followed by “t1”)

FIG. 6 shows the principles of a two channel measurement by a selective thermo scanning of an interference filter on the basis of different time slot,

FIG. 7 shows an example of a sensing means or a light receiver means with two adjacently arranged opto-electric detectors, in accordance with the present invention,

FIG. 8 shows a graph of the angular dependency of the transmission of wavelengths of an interference filter intended for NDIR-technology, (Centre Wavelength Shift, as a typical NDIR gas detection using a narrow band pass filter),

FIG. 9 shows a graph of a typical application in a two channel measurement with a carbon dioxide sensor and by a differential absorption measurement, (NDIR Single Filter Dual Wavelength CO₂ Gas Sensing, with filer curves for a standard 4.26 μm CW filter for CO₂ monitoring),

FIG. 10 shows an optical arrangement having two light detectors, related to the present invention,

FIG. 11 shows a graph of an application of the present invention for evaluation di-methyl ethane (DME) from butane, (Hydro-Carbon Differentiation),

FIG. 12a illustrates an example of an embodiment of the invention in which the transmitted electromagnetic radiation is to be able to be distributed over the band-pass filter to each of four light sensing means, in more than two adjacent analysis wave-lengths and in an enlarged view, FIG. 12b shows an alternative of such four light sensing means,

FIG. 13 illustrates a graph of the application of the invention for distinguishing detection of various specific gas components of hydrocarbons, (NDIR Single Filter Triple Wavelength Gas Sensing, with filter curves for a standard 3.46 μm CW filter for HC monitoring), and

FIG. 14 is illustrating the orientation of two light sensing means adjacently oriented in a side-by-side relation for receiving its light beams and its wavelengths.

### DESCRIPTION OF THE PRESENTLY PROPOSED EMBODIMENT

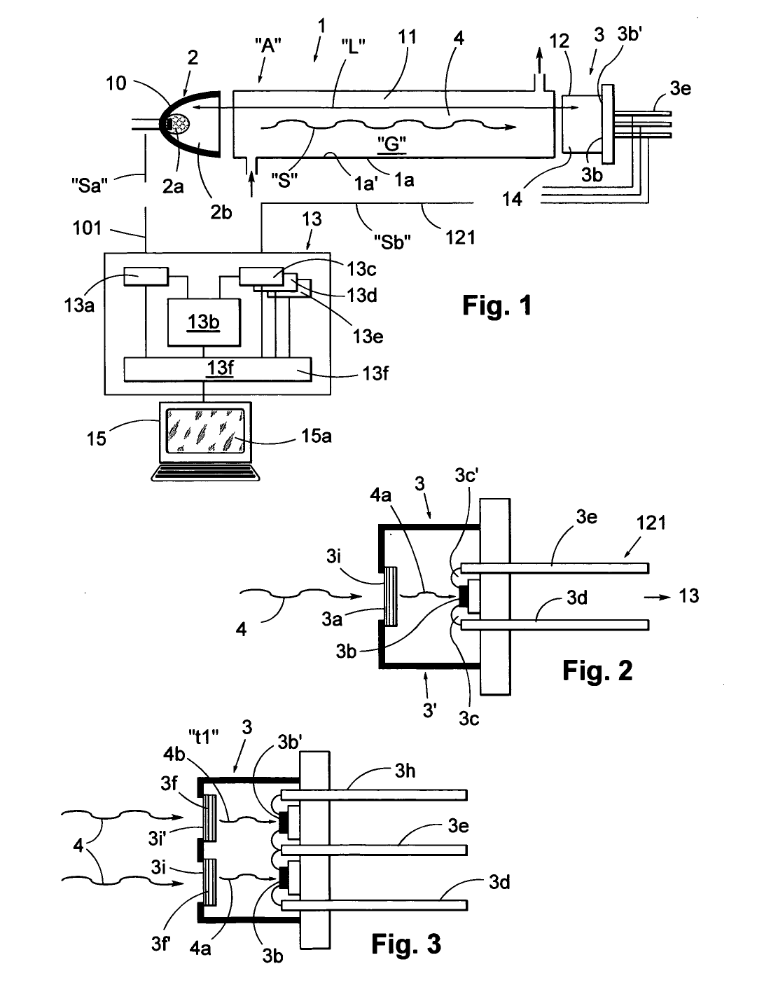

It shall initially be pointed out that in the following specification concerning a presently proposed embodiment which exhibits the significant characteristics related to the invention and which will be clarified by means of the FIGS. 1 to 14, shown in the following drawings, we have chosen terms and a specific terminology with the purpose of primarily clarifying the basic concept of the invention.

However, in this connection it should be noted that the terms chosen here shall not be seen as limiting solely to the terms utilized and chosen here and it should be understood that each thus chosen term is to be interpreted such, that it in addition will be able to comprise all technical equivalents that function in the same or substantially the same manner so as to thereby be able to achieve the same or essentially the same purpose and/or technical result.

Thus, with reference to the accompanying drawings the basic prerequisites for the present invention are shown schematically and in detail and in which the significant peculiarities related to the invention have been concretized by the now proposed and in the following more specifically described embodiment.

Thus, FIG. 1 schematically shows the principles of an arrangement “A” adapted for a spectral analysis with an adapted light transmitting means unit 10 for electromagnetic radiation “S” with a large wavelength interval and a delimited space 11 in the form of a cavity, serving as a measuring cell or measuring path adapted for a sample of gas “G” and intended to be able to define an optical measuring distance “L”.

Furthermore a light sensing means 12 for said electromagnetic radiation “S” which passes said optical measuring distance “L” from said light transmitting means 10 is illustrated, as well as, at least to said light sensing means 12 and therein included opto-electric detectors 3b, 3b′, over a line 121 connected unit 13 performing the spectral analysis.

Furthermore the mentioned means 12 sensing the electromagnetic radiation “S” and detectors 3b, 3b′ associated therewith should be adapted to be sensitive for the electromagnetic radiation which is intended to fall within the spectral area whose chosen wavelength components or spectral elements are to be the object of an analysis in the unit 13, performing the spectral analysis, for primarily in this unit 13 calculating and determining the relative light radiation intensity of the spectral elements.

It should be noted that in FIG. 1 the light transmitting means 10 and the light receiving means 12 are illustrated somewhat removed from the delimited space 11 solely for clarification purposes.

Said transmitted electromagnetic radiation “S” between said light transmitting means 10 and said light sensing means 12, is adapted to be permitted to pass towards and selectively to an adapted band-pass filter, such as an optical band-pass filter 14.

Such a band-pass filter 14 is structured and/or designed to be able to offer a wavelength dependent of the incident angle in the transmission of the electromagnetic radiation “S” generated by said light transmitting means 10.

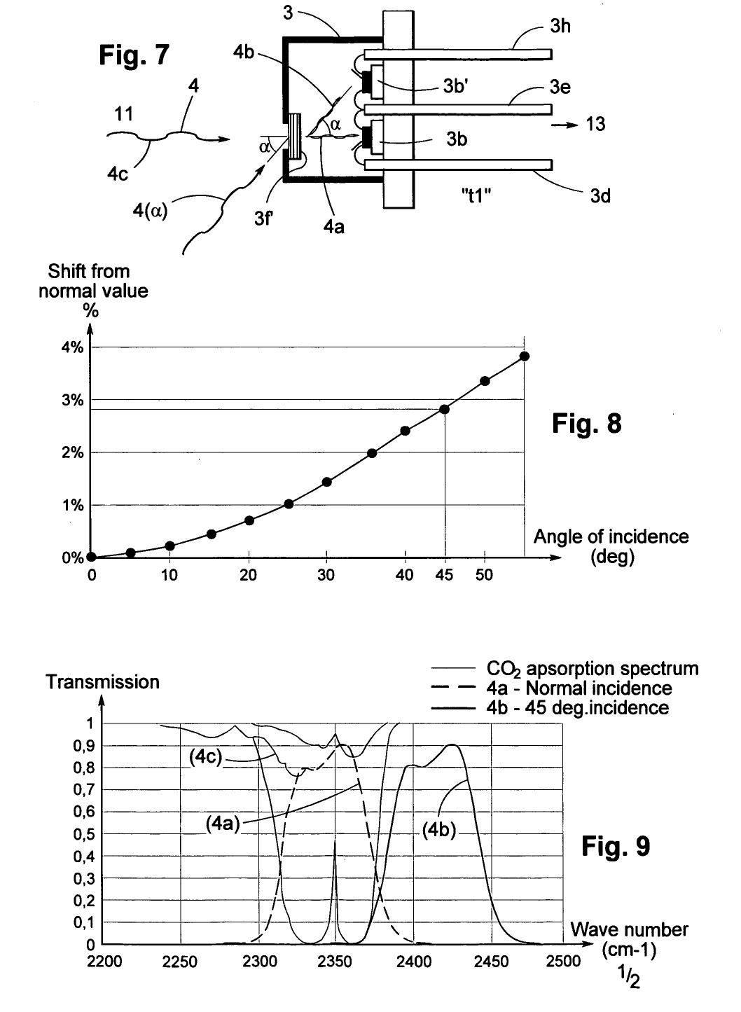

This band-pass filter 14 is thus adapted to separate (FIG. 7) from a chosen angle of incidence a first chosen spectral element 4a directed towards a detector 3b from a second chosen spectral element 4b directed towards a detector 3b′, and in addition two opto-electric detectors 3b and 3b′ both are connected to said unit 13 which is adapted with modules to be able to detect an occurring radiation intensity for more than one such spectral elements.

The unit 13 (FIG. 1) is performing the spectral analysis and exhibits a transmitter module 13a controlled by electromagnetic radiation “S” and activated by a central unit 13b, and a number of signal receiving modules 13c, 13d and 13e, also connected to the central unit 13b over said line 121.

Over a circuit 13f signals, electromagnetic radiation “Sa”, sent via the light transmitting means 10 can be compared to a received electromagnetic radiation “Sb” in the light sensing means 12. To do this a line 101 and a line 121 are used.

The evaluated and calculated result in the central unit 13b can then be transferred to a display unit 15 as a graph 15a.

More specifically FIG. 1 illustrates an application with an absorption cuvette 1, in which cuvette 1 the gas “G” which is to be analysed by means of the electromagnetic radiation “Sb” is located, or considered as a light radiation bundle 4, is to be analysed, wherein the radiation “Sa” is transmitted by an emitter unit 2 and received by an electro-optical detector unit 3.

This light emitter unit 2 can then consist of a radiation source 2a (the means 10) and a coordinated collimeter 2b having the purpose of gathering as effectively as possible the emitted radiation “Sa” with its radiation bundles 4, and directing the same through the length of the absorption cuvette 1 towards the detector or receiver unit 3.

The emitter unit 2 can take the form of a glowing wire in a glass bulb filled with gas or with gas evacuated, i.e. an incandescent lamp or a heated resistor on a ceramic substrate or on a thin membrane produced by silicon technology and micro mechanics or a light emitting diode, with a well defined spectrum of emission.

In accordance with the instructions of the invention the emitter unit 2 is to send out an emission “Sa” of radiation bundles 4 which at least must include all of the wave-lengths whose intensities are to be detected opto-electrically in individual detectors 3b, 3b′ in FIG. 1 (and detectors 3b, 3b′ in FIG. 7) and to be evaluated in the unit 13.

The absorption cuvette 1 can then be designed in different ways depending on the chosen application, the chosen exactness in measuring, the manner in which the measuring gas “G” can be expected to be gathered, via negative pressure or positive pressure, etc.

In certain applications the absorption cuvette 1 can at the same time comprise the mechanical base 1a to which the light emitter unit 2 and the light receiver unit 3 are rigidly fastened.

The detectors 3b, 3b′ of the receiver unit 12 are adapted to generate the electrical signals which are dependent of the opto-electrical wavelengths and which later are to be made subjects of a calculating analysis in the unit 13, for performing the spectral analysis.

Such units 13 are well known in this technical field and are therefore not described in detail.

Said unit 13 is intended to calculate the result that shows a relevant gas concentration and/or a gas and/or a gas mixture.

In order to be able to offer an increasing necessary measuring sensitivity, such as to extend the length of the measuring distance or the absorption distance “L”, this can be realized by various optical arrangements, such as by multiple passages back and forth within the used measuring cell or the restricted space 11, so-called multi pass cells.

In order furthermore to be able to collect the emitted electromagnetic bundles 4 of rays, which reflector or collimeter 2b is not able to collimate in the desired and correct direction it is possible to utilize absorption cells with mirrored inside surfaces 1a′ in a known manner and with the geometry designed such, that the light bundles from emitter unit 2 is led forward to the receiver unit 3 as a waveguide.

FIG. 2 now schematically illustrates a known light receiver unit 3 adapted for a one-channel measuring, wherein the transmitted incoming light ray 4 is filtered optically by an interference filter 3a, which in this example is mounted to serve as a window on the encapsulation 3 of the receiver unit 3 in connection with an opening (an aperture) 3i in the encapsulation 3′ so that solely electromagnetic radiation or light rays 4a within a very narrow and well defined spectral interval passes filter 3a and reaches an opto-electric detector 3b which is sensitive to this radiation.

The opening 3i has the functions of filtering spatially, i.e. solely letting in towards detector element 3b the electromagnetic radiation 4a which coincides with the direction from emitter unit 2 and suppressing light and radiation from other directions which otherwise will be able to contribute negatively and disturbingly to the calculated result in unit 13.

Therefore the walls 1a′ furthermore comprise a shielding to the environment as well as to the structure of the receiver unit 3.

Detector element 3b can be of the type of a photo diode, quantum detector, pyroelectric detector or another form of thermal detectors for opto-electric conversion.

It is important that the opto-electric detector 3b, in FIG. 2, has the ability to generate some kind of or some form of electric signals whose size and shape is to be dependent of and correspond to the intensity of the radiation 4a passing through filter 3a within its frequency interval.

By the illustrated electric connections 3c, 3c′ these electric signals are transferred to two measuring connections 3d and 3e of the light receiver unit 3, from which a following amplifier stage (not shown) in unit 13 and/or other electronics/computer processing refine the measuring signal to a final result, which may be evaluated and which is visible as a graph 15a on a display unit 15.

If gas measuring is to be carried out on the basis of NDIR technology the wave-length of the filter transmission 4a is chosen to coincide with an absorption wavelength characteristic of the matter for which the gas concentration is to be measured.

FIG. 3 now shows schematically a known receiver unit 3 for a two channel measurement, and this receiver unit 3 has, in addition to what has been shown and described in connection with FIG. 2, been provided with an additional opening 3i′, with an interference filter 3f behind it and with individual associated opto-electric detector elements 3b and 3b′.

Filter 3f is here chosen with another transmission wavelength 4b than filter 3f′, and therefore the selected light beam 4b will have a different wavelength than the selected light beam 4a.

Corresponding, into electrically measurable signals converted, signals on the connector pins 3h, 3e and 3d are used for wavelengths 4b and 4a, respectively, pins 3d, 3e for wavelength 4a, is providing information about momentary light intensities.

Short time variations in the inwardly radiated intensity of the electromagnetic radiation (4) “S” or light rays “Sa”, which bear the risk of distorting an accurate evaluation of the measuring signals 121 can be neutralized and regulated away entirely if one of the measuring channels is used as an intensity reference for a signal-neutral wave-length.

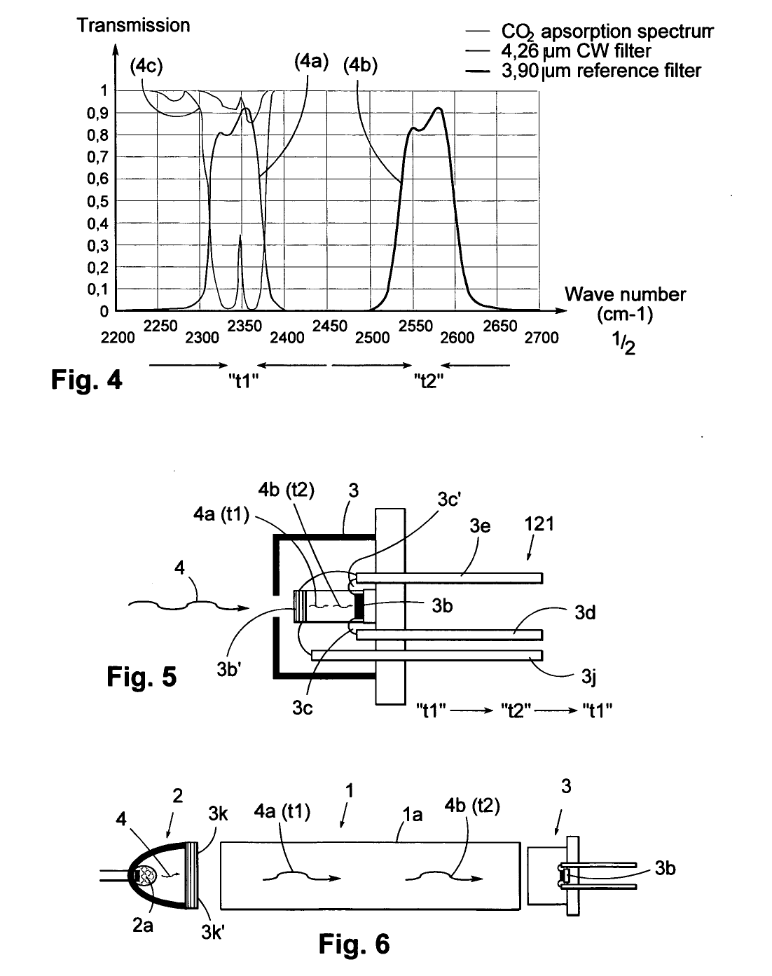

FIG. 4 shows a graph for illustrating an application in a two-channel measurement for a carbon dioxide sensor, according to FIG. 3, by means of a differential absorption measurement.

The characteristic of interference filter 3f′ is chosen such, that its transmission graph (4a) coincides with the absorption area (4c) of the measuring gas, in this case a wavelength around 4.26 μm for carbon dioxide. The scale in FIG. 4 is defined by the value of 1/λ.

Another filter (not shown) can be chosen for creating a reference signal by having its transmission characteristic (4b) chosen to lie in an area where no gas absorption occurs or exists, in this example around a wavelength of 3.39 μm.

By initially having the instrument calibrated and measuring the signal quotient that these signals generate in a situation in which no carbon dioxide is present, the measuring system can be standardized in this way and be made independent of variations in the radiation intensity of the light bundles 4 of beam.

The ageing tendencies of the emitter 2a as well as transmission changes in the optical system 11 cause the intensity of bundles 4 to vary in time, which in practice is what mostly limits the exactness of a NDIR gas meter and sets up requirements of recurring service and need of recalibrations.

This forming of quotients between the signals of gas absorption and reference wavelength related electrical signals between terminals 3d-3e and 3h-3e improves the situation considerably as compared to a system for a one-channel measuring system according to FIG. 2.

FIG. 5 now illustrates a two-channel measurement by an electrical scanning of an interference filter 3b′ and 3b selected in time.

An alternative embodiment of an NDIR two-channel measuring is when the transmission wavelength for one and the same interference filter 3b′ can made to vary electronically by means of an external, applied control signal over a connection, not shown.

In different time sequences “t1” and “t2”, radiation 4a(t1) with wavelength 4a can be transmitted in a time interval “t1”, whereas radiation 4b(t2) with reference wave-length 4b is transmitted in a time interval “t2”.

By alternately permitting the two predetermined wavelengths 4a, 4b to pass during these different time intervals a signal quotient can be formed afterwards, in accordance with the basic concept of wavelength differential absorption measuring, in accordance with FIG. 4.

The electronically controllable optical transmission filter 3b′, in FIG. 5, can be realized with micromechanics in silicon based processes, wherein a so-called Fabry-Perot filter can be etched forth in such manner that one mirror surface thereof becomes controllably displaceable on a micro-scale so as to thereby offer a time-controlled Fabry-Perot interference meter transmission wavelength.

Further, it lies within the scope of the invention to arrange mechanical rotation of filter 3b′.

FIG. 6 illustrates a two-channel measurement by a thermal similar scanning of an interference filter 3k.

Another concept is illustrated here for enabling the creation of prerequisites for forming a quotient of wavelength differentiated signals, according to FIG. 6, by utilizing a simple detector unit 3b, without any wavelength selecting filter adjacent to detectors 3b, in combination with a wavelength modulating emitter unit 2a with pulsed bundles of radiation 4a(t1) and 4b(t2), as in FIGS. 4 and 5.

This emitter unit 2 (2a) realizes the forming of wavelength segments by using interference filter 3k as a window or an opening in the emitter unit 2a and adjacent to the emitter instead of having a filter mounted adjacent the receiver unit 3.

It has turned out that by using metal oxides, with substantial temperature dependence in their reflective index, a temperature scanning interference filter 3k can be created, in which the transmission wavelength varies considerably with the instantaneous temperature of filter 3k.

In view of the proximity of filter 3k to the power delivering emitter unit 2 (2a) it will be heated to different equilibrium temperatures depending on the output of the emitter unit 2 (2a).

A power modulation of emitter unit 2 and associated radiation 4 will thus generate a corresponding temperature modulation in filter material 3k and hence a wave-length modulation of the transmitting light 4 whose extreme wavelength values 4a(t1) at time slot “t1” and 4b(t2) at time slot “t2” provide the basis for forming a quotient, basically in the manner as illustrated in FIGS. 5 and 6.

The specific qualities related to the invention will now be described with reference to FIGS. 7 to 12.

FIG. 7 has the purpose of illustrating a light receiver unit 3, exhibiting the qualities or features related to the present invention.

More specifically, FIG. 7 has the purpose of showing a receiver unit 3 which can be considered to be a simplification of the embodiment shown in FIG. 3 in consequence of filter unit 3f not being included in this structure but only filter unit 3f′.

Its two associated detector elements 3b, 3b′ are here nevertheless illustrated each by receiving an individual radiation bundle 4a and 4b over one the same filter unit 3f′, with the difference that the bundle rays 4b are to exhibit an angle 4(α) in its direction of propagation relative to the direction of bundle rays 4 and bundle rays 4a.

It is known per se that the transmission wavelength of an interference filter decreases with an increasing angle of incidence (α) from normally inciting bundle of rays 4 towards filter 3f′.

This results in that by an arrangement, according to FIG. 7, prerequisites can be created, as in FIG. 3, and can be utilized for performing a differential absorption signal measuring, in accordance with the principle illustrated in the graph of FIG. 4 however during one time slot “t1” only.

It has turned out that a prerequisite for this is that the surrounding optics are designed such, that the emitted and (partly) collimated radiation 4, at least in a specific part 4(α), is deflected and is directed towards filter 3f′ with the angle of incidence “α”.

An arrangement is shown here, which in a cost effective manner can measure the strength of a signal at two different and separated wavelengths, wherein one single filter 3f′, according to FIG. 7, will be more cost effective than the two filter units 3f, 3f′ which are illustrated in FIG. 3.

Furthermore, it has turned out that a precision reached for the difference in wavelength will be very great and greater than it is practically/economically possible to accomplish with two different optical filter units (3f, 3f′).

If it is noted that a common value of a tolerance for the transmission wavelength of optical filters is +/−1% and that the difference in transmission wavelength between two filter units have, at the time of purchase, an uncertainty of +/−2% of the working wavelength it has turned out that a corresponding value for the arrangement according to the invention, typically is +/−10% of the values disclosed above for the transmission wavelengths.

FIG. 8 has a purpose of illustrating, in a graph, the angular dependency of the transmission wavelength of a typical interference filter, intended for a NDIR gas measuring.

The diagram should speak for itself, but illustrates that a typical value for changing the transmission wavelength at an angle of incidence of for example 45° relative to the nominal value at a normal incidence of light is approximately 3% of the transmission wavelength and with a maximized uncertainty of approximately 0.3%.

FIG. 9 illustrates in a graph an application of a two-channel measurement for a carbon dioxide sensor by a differential absorption measuring in accordance with the indications of the invention.

Applying the arrangement, in accordance with the invention as in FIG. 7, in a NDIR gas sensor with an interference filter, according to FIG. 8, with a standard characteristic provides signal or filter characteristics (4a) and (4b) which fulfil the basic conditions for a differential NDIR absorption measurement of carbon dioxide (4c) according to the two-channel measurement principle.

The size of or envelop of the graph indicates the magnitude of the gas concentration.

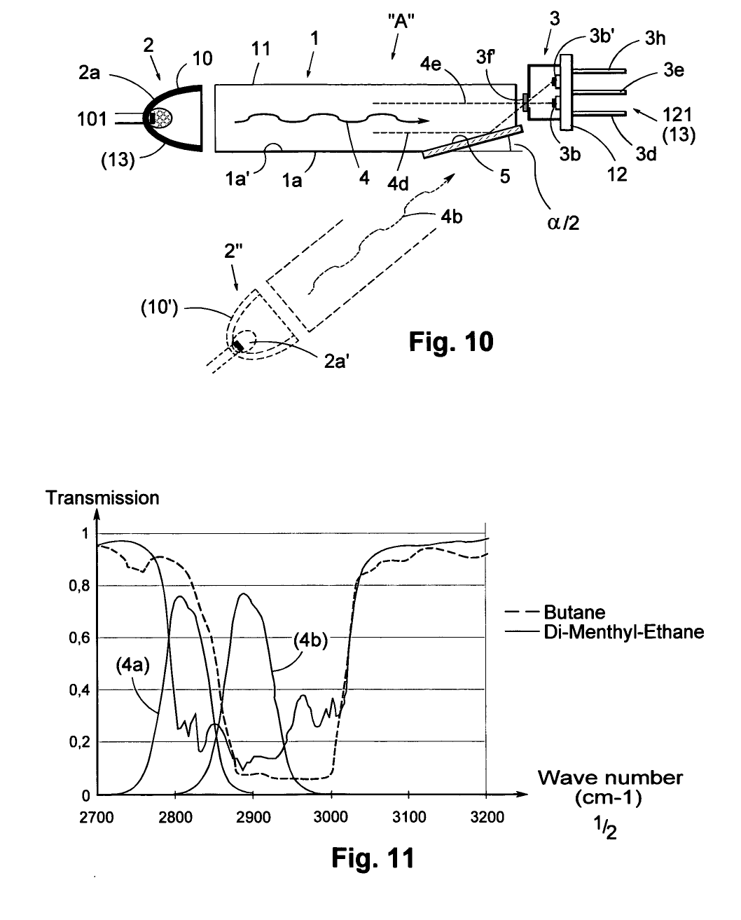

FIG. 10 illustrates a further optical arrangement “A”, in accordance with the principles of the invention.

Compared to the NDIR embodiment of FIG. 1 it is indicated here that the light receiver unit 3 is replaced by a structure which is more specifically shown and described in FIG. 7 but somewhat moved or displaced upwards, with the purpose of letting the lower detector element 3b be directly illuminated by the light beam or bundle 4e (4a) which has passed within the upper half of the measuring cell 1.

The uppermost detector element 3b′ will then be illuminated by the light beam or bundle 4d (4b) which has passed through the lower half of the measuring cell 1 but which has been angled upwardly towards detector 3b′ by the introduction of a small reflecting mirror surface 5.

Mirror surface 5 is here mounted at an angle of “a/2” as compared to the original propagation direction of the light bundle 4d so that the angle of incidence towards the interference filter 3f′ will have the value “a” desired for the arrangement, seemingly originating in the virtual illustration 2″ of emitter unit 2a′, (10′), at the bottom of FIG. 10.

There are a number of possible solutions with an arrangement “A” and variations thereof which can generate the angles of incidence necessary for the light receiver unit 3 and its detectors 3b, 3b′.

With reference to FIG. 11 there is illustrated a graph in an example of applicability for being able to distinguish di-methyl-ethane (DME) from butane.

It is here illustrated the manner in which the quality of a fuel can be measured by checking the DME-mixture.

This can be done, in accordance with the directions of the invention, and can be applied in process supervision by a differential absorption measuring (4a), (4b) at the wavelength pair of 3.56 μm and 3.45 μm.

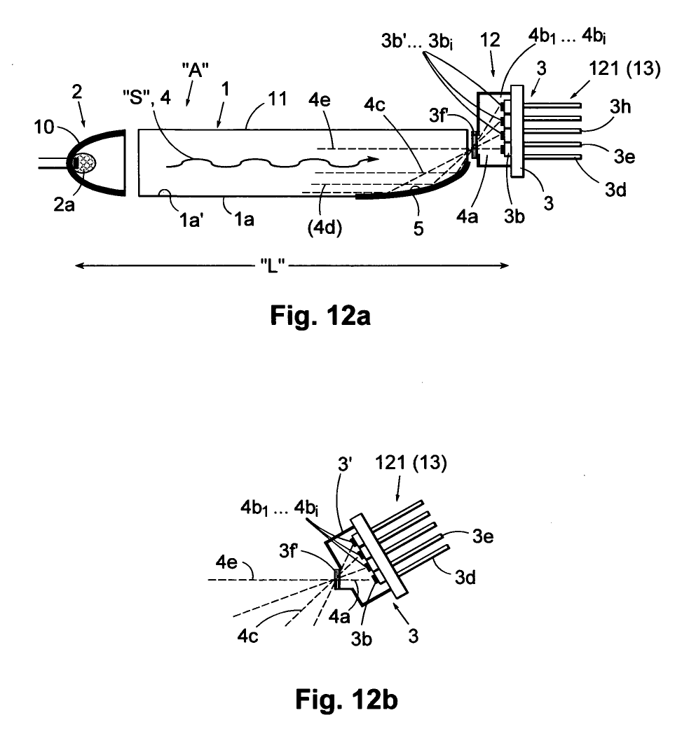

FIG. 12a illustrates an embodiment of the arrangement “A”, in accordance with the invention, and which can evaluate a plurality, more than two, of analysis wave-lengths lying close at hand or adjacent each other.

It is mentioned here that a plurality of wavelengths 4a (related to the bundle 4e), 4b₁ . . . 4bᵢ can be separated and, as FIG. 12a shows, forming and using a specific light receiver unit 3.

The arrangement is then to comprise equally many opto-electric units or detector units 3b, 3b′ . . . 3bᵢ as the selected wavelengths, wherein all of the detectors are mounted in a row, a detector array, so that substantially different angles will illuminate each one of them all.

Analysis of hydrocarbons can be considered to be a typical example of when a differential absorption measurement at several closely lying wavelengths can be needed for having the possibility of being able to separate different carbon matter in a connection with mixed gases.

FIG. 12b illustrates an alternative embodiment of a light receiver unit 3′ adapted to be able to discern a plurality of analysis wavelengths lying close at hand.

Here geometry is shown, in which the wavelength selecting filter 3f′ is centrally located but angled within the encapsulation 3′ of the receiver unit 3.

This can then bring about a more uniform lighting/projection between the various detector elements 3b, 3b′ . . . 3bᵢ for the wavelengths 4e and its sections 4a, 4b₁ . . . 4bᵢ.

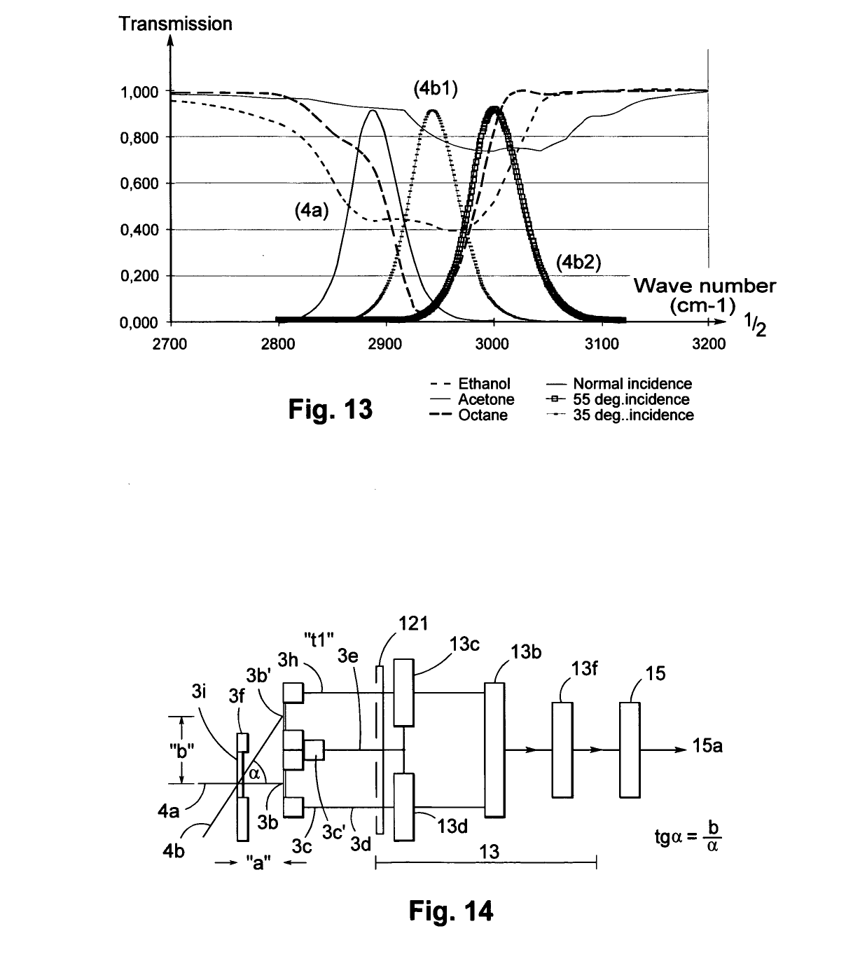

FIG. 13 illustrates in a graph an application of the invention in order to be able to differentiate the detection of specific gas components of hydrocarbons.

It is known that minor differences exist in the absorption spectrum of closely related substances and this is here exemplified at a wavelength of approximately 3.4 μm.

This applies to carbohydrates such as ethanol, acetone and octane.

It has turned out that it is difficult to separate these substances with precision with known principles of gas measuring which are designed in utilizing semi-conductor sensors and electrochemical measuring cells.

However, it has turned out that a differential measuring of absorption in the spectral areas (4a), (4b1) and (4b2) in accordance with the directions of the invention can discern these matters from each other, detect which matter is a relevant one and how great a portion of the matter which exists within the measuring cell, particularly in situations when only one or a small number of these matters at a time are exposed within the measuring cell 11 of the equipment “A”.

Still more complicated situations with gas mixtures and with several possible gases present can be evaluated with greater or lesser precision with the assistance of the present invention on the condition that the associated spectra exhibit mentionable and/or differences and where the arrangement can, as its basis have a gas analysis which comprises more than the two measuring channels, illustrated here in FIG. 7, such as three, four, five or more as in FIGS. 12a and 12b.

The optical band-pass filter 3f′ is adapted in dependence of a chosen angle of incidence of the radiation “S” to deflect each incoming electromagnetic radiation into at least two, often more, different optical and predetermined outgoing angles, wherein said outgoing angles are to be related to a main angle of the incoming radiation 4 and its part 4c or 4e which is to be subjected to analysis in the unit 13, performing the spectral analysis.

At least one and the same band-pass filter 3f′ is to be adapted to receive one and the same electromagnetic radiation 4 within which fall at least two different wave-length components or spectral elements.

For each, or for each selected, outgoing angle there exists at least one opto-electric detector 3b, 3b′ which is adapted to have, in the unit 13, performing the spectral analysis, by calculations, its associated spectral element's intensity analysed in relation to the intensity of a transmitted electromagnetic radiation 4 (“S”).

FIG. 14 is illustrating the orientation of two light sensing means 3b, 3b′, during a time slot “t1”, adjacently oriented in a side-by-side relation for receiving its light beams 4a, 4b and its wavelengths.

The distance “a” is indicting the minimum distance between the filter 3f′ surface and its slot 3i in relation to the minimum distance “b” between the light sensing surface for the detectors 3b′ and 3b.

It is here illustrating the parallel processing (t1) of the signal (3d, 3e) and (3h, 3e) in the signal receiving modules 13c and 13d further prosecuted in the central unit 13b to cause the graph of the signals, as (4a) and (4b) in the FIGS. 9, 11 and/or 13.

By extending the distance “a” more detectors than the two shown may be introduced, as shown in FIG. 12a and FIG. 12b.

The invention is of course not limited to the embodiment disclosed above as an example and can be subjected to modifications within the frame of the inventive concept which is illustrated in the following claims.

It should be particularly noted that each illustrated unit and/or circuit can be combined with each one of the other illustrated units and/or circuits within the frame of being able to achieve the desired technical function.

1. An arrangement adapted for a spectral analysis, said arrangement having a light transmitting means adapted for electromagnetic radiation, a space, and a light sensing means for said electromagnetic radiation from said light transmitting means, as well as a unit performing the spectral analysis and being connected at least to said light sensing means, wherein said sensing means is adapted for sensing the electromagnetic radiation over detectors opto-electrically adapted sensitive to the electromagnetic radiation or spectral elements are to become the object of an analysis in said unit performing the spectral analysis having a relative radiation intensity of the spectral elements determined in said unit, by calculations, wherein said electromagnetic radiation is adapted to pass with different angles of incidence, an adapted optical band-pass filter between said light transmitting means and said light sensing means, that the band-pass filter is structured and/or constructed so as to be able to offer a wavelength dependent of the angle of incidence for transmission of the electromagnetic radiation generated from said light transmitting means, with said band-pass filter in this connection being adapted to have separated a first chosen wavelength component and/or a first chosen spectral element in dependence of an angle of incidence from a second chosen wavelength component and/or a second chosen spectral element each for being received in its opto-electric means or detector and said unit being adapted to be able to detect and calculate separately an occurring radiation intensity for more than one wavelength component and/or one spectral element.

2. An arrangement adapted for spectral analysis having a light transmitting means adapted for electromagnetic radiation, a delimited space, in the form of a cavity, serving as a gas adapted measuring cell and intended to be able to define an optical measuring distance, a light sensing means for said electromagnetic radiation passing through said optical measuring distance from said light transmitting means, and a unit, performing the spectral analysis, connected at least to said light sensing means, wherein said mentioned means, sensing the electromagnetic radiation, is opto-electrically adapted sensitive to the electromagnetic radiation which is intended to fall within a spectral area whose chosen and selected wavelength components or spectral elements are to become objects of an analysis within said unit performing the spectral analysis so as to, in this unit, over calculations, determine the relative radiation intensity of the spectral elements, wherein said electromagnetic radiation is adapted, between said light transmitting means and said light sensing means, to be allowed to pass an adapted optical band-pass filter, that the band-pass filter is structured and/or constructed so as to offer a wavelength dependent on the angle of incidence for transmission of the electromagnetic radiation generated by said light transmitting means, wherein said band-pass filter is adapted to separate a first wavelength component and/or a first chosen spectral element from a second chosen wavelength component and/or a second chosen spectral element for being received each in its opto-electric means or detector, and that said unit is adapted for being able to detect and calculate separately an occurring radiation intensity for more than one received wavelength component and/or one spectral element.

3. An arrangement in accordance with claim 1, characterized in that adjacent to said band-pass filter or within said filter there is positioned an opening or a window delimiting the dispersion angle of the electromagnetic radiation.

4. An arrangement in accordance with claim 1 wherein said opening or window is oriented before and/or behind said band-pass filter, counted in the direction of radiation.

5. An arrangement in accordance with claim 1, wherein the bandpass filter is adapted in response to a relevant angle of incidence to deflect incoming electromagnetic radiations into at least two different electromagnetic and optical and predetermined outgoing angles.

6. An arrangement in accordance with claim 5, wherein said outgoing angles are related to a main angle of the incoming radiation, which is to become the object of an analysis within the unit performing the spectral analysis.

7. An arrangement in accordance with claim 5, wherein one and the same band-pass filter is adapted to receive one and the same electromagnetic radiation within which fall at least two individual spectral elements.

8. An arrangement in accordance with claim 5 wherein a pre-chosen plurality of band-pass filters are adapted for each one receiving its electromagnetic radiation, within which radiations are included in least two individual spectral elements.

9. An arrangement in accordance with claim 5 wherein for each, or each selected angle associated with an outgoing beam or ray there is an opto-electric detector which is adapted to have its associated spectral element analysed, in said unit performing the spectral analysis, by supplied electric at least two signals and calculations.

10. An arrangement in accordance with claim 1, wherein as said band-pass filter is chosen a filter active on the basis of optic interference.

11. An arrangement in accordance with claim 1, wherein said opening, said band-pass filter and/or included channels, related to said unit, performing the spectral analysis, are coordinated to means, receiving and/or sensing one and the same signal.

12. An arrangement according to claim 11, wherein said opening, said band-pass filter and said channels are coordinate to one and the same light receiving means.

13. An arrangement in accordance with claim 11, wherein said receiving unit is allotted the form of a hybrid unit.

14. An arrangement in accordance with claim 11, wherein said delimited space, shaped as a cavity, exposing a measuring portion and/or an optical measuring distance, is allotted a straight and/or radiation reflecting shape, between the light transmitting means and the light sensing means.

15. An arrangement in accordance with claim 14, wherein the light transmitting means is shaped as a first discrete unit and the light sensing means is shaped as a second discrete unit adapted to cooperate with an intermediate aperture-shaped partial portion with an inlet and an outlet for the gas intended for sensing and analysing.

16. An arrangement in accordance with claim 15, wherein the gas intended for sensing and/or analysing consists of expiratory air and that chosen sensing and/or analysing is directed towards determining the presence of and/or a concentration of aicohαi or corresponding drugs.

17. An arrangement in accordance with claim 15, wherein the concentration of carbon dioxide (CO₂) is evaluated and is presented as a graph on a display unit.

18. An arrangement in accordance with claim 15, wherein an end portion of the delimited space, facing the light sensing means, exhibits a surface portion reflecting electromagnetic radiation for deflecting the transmitted electromagnetic radiation obliquely towards one or more opto-electric detectors.

19. An arrangement in accordance with 18, wherein a light ray or beam or a selected portion of light rays or beams, related to the chosen electromagnetic radiation are adapted to be directed straight towards an opto-electric detector from the light transmitting means.
